(19) United States
(12) Patent Application Publication
(10) Pub. No.: US 2007/0205536 A1
(43) Pub. Date: Sep. 6, 2007

(54) Method for stamping an embossment on ribbon

(76) Inventor: Sen-Mei Cheng, Ho Mei Town (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/433,444

(22) Filed: May 15, 2006

(30) Foreign Application Priority Data
Mar. 6, 2006 (TW) 95107483

(51) Int. Cl. B29C 49/00

(52) U.S. Cl. 264/284

(57) ABSTRACT

A method for stamping an embossment on ribbon is provided. First, a ribbon is employed as a substrate. Then, at least one layer of plastic-material covers the substrate. A drum emboss calender machine, which has patterns on the roller, is applied to stamp the embossment on the ribbon. Finally, the continuous or discontinuous embossment can be stamped on the ribbon by using the drum emboss calender machine. The embossed ribbon can be provided with various styles and features, and can enhance the visual impression.

### RELATED APPLICATIONS

The present application is based on, and claims priority from, Taiwan Application Serial Number 95107483, filed Mar. 6, 2006, the disclosure of which is hereby incorporated by reference herein in its entirety.

### BACKGROUND

1. Field of Invention

The present invention relates to a method for stamping an embossment on ribbon, and more particularly to a method for stamping an embossment on ribbon continuously.

2. Description of Related Art

Knitted ribbons are used extensively because of their decorative function. They are used to make back straps, adornments and so on. There are many different changeable colors and knitting styles that can be used for the general appearance of knitted ribbons, but pattern design is also an important element.

Some methods for forming patterns on knitted ribbons do exist. One method is knitting; however, this method can only be used to create geometric pictures or simple words because of the restrictions on both the size of the knitted ribbon and knitting technology so that vivid, shiny patterns can not be created. Another method for forming patterns on knitted ribbons is transfer printing; this method forms patterns on the transfer-printing layer by pressing and heating the pattern on to the shiny material. The pressing and heating allows different colorful patterns to be displayed on the knitted ribbons. However, these patterns can only be displayed in the form of a plane and lack stereo effects; furthermore, it is difficult to maintain the completeness of the pattern because some colors fall off.

Recently, some knitted ribbons with stereo-patterns were printed using the pre-molding method which makes plastic, foil or other material into a pattern, and then stamps this pattern on to the knitted ribbons; as a result, reflective, stereo patterns are formed. However, this process will raise the production cost because of its complicated steps and discontinuous manufacturing.

Another method of creating stereo patterns on knitted ribbons is to sew reflectors or laser bars on the knitted ribbons. In this case the knitted ribbons are covered with protective, transparent films in order to prevent the laser bars and reflectors from falling off. Yet, these reflecting knitted ribbons will have production restrictions because of their raised thickness and harder quality.

### SUMMARY

It is therefore an objective of the present invention to provide a method for stamping an embossment on ribbon in order to reduce or prevent discontinuous manufacturing of the conventional knitted ribbon because the stereo embossment is stamped using a single mold.

It is another objective of the present invention to provide a method for stamping an embossment on ribbon in order to solve the problems of conventional reflecting knitted ribbons that are changeless in appearance, harder in substance and requirement of multi-processes.

In accordance with the foregoing objectives of the present invention, a method for stamping an embossment on ribbon is provided. The ribbon is the substrate on which the embossment is stamped, and the stamping material covers the ribbon. Then the drum emboss calendar machine is used with the stamping embossment to continuously or discontinuously stamp patterns on both the ribbon and the material.

In the preferred embodiment of the present invention, the ribbon on which an embossment is stamped can be knitting cloth or weaving cloth, like cotton, polyester, nylon, polyester nylon fiber, mixed yarn cloth and so on; it can also be thermoplastic film, like thermoplastic polyurethane elastomer (TPU) or polyvinyl chloride (PVC). The material covering the substrate on which the pattern is stamped and embossed can be TPU, PVC, reflecting film, laser film or a combination thereof. Moreover, the method by using multi-layered material, for example reflecting film combined with TPU can be the material on which the pattern is stamped then embossed, can provide one-piece reflecting ribbon with stereo-pattern. Compared to the general methods by attaching or sewing reflecting bars on to the knitted ribbon, this method not only decreases the complexity of the process but also maintains the thickness and the hardness of the knitted ribbon.

In the preferred embodiment of the present invention, the roller of the drum emboss calender machine is etched with the pattern. The etching methods include intaglio, relief or by pattern molds. The patterns can be stamped on the ribbons continuously by pressing and rolling, so the stereo-patterns on the ribbons can either be convex or concave. The embossed patterns of the etching or on the molds can be a continuous or discontinuous arrangement so patterns with different visual effects can also be embossed on the ribbons. As a result, there are many advantages of the present invention over the prior art, such as:

1. The method for stamping an embossment on ribbon of present invention using the drum emboss calendar machine allows for continuous manufacturing. Continuous or discontinuous stereo patterns can also be stamped on ribbon with different embossment arrangements. Therefore, the entire production process can be automated and rapid, so this automated and rapid production process not only raises productivity but also decrease the cost.

2. The method of the present invention can produce one-piece ribbon with a stereo pattern by means of different ribbons and materials. Therefore, functional and stylish knitted ribbons are provided and different visual effects are displayed so that they can be applied more extensively and boost the market competitiveness.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 illustrates a step flowchart for the method of stamping an embossment on ribbon using the preferred embodiment of the present invention;

FIG. 2 illustrates a diagram for the method of stamping an embossment on ribbon using the preferred embodiment of the present invention;

FIG. 3 illustrates a diagram for the entire automatic method of stamping an embossment on ribbon using the preferred embodiment of the present invention;

FIG. 4A illustrates a diagram of the continuous embossment using the preferred embodiment of the present invention;

FIG. 4B illustrates a diagram of the discontinuous embossment using the preferred embodiment of the present invention;

FIG. 4C illustrates a diagram of the irregular embossment using the preferred embodiment of the present invention;

FIG. 5 illustrates a diagram for the method of stamping an embossment on single ribbon using the preferred embodiment of the present invention;

FIG. 6 illustrates a diagram for the method of stamping an embossment on ribbon with single material using the preferred embodiment of the present invention;

FIG. 7 illustrates a diagram for the method of stamping an embossment on ribbon with two materials using the preferred embodiment of the present invention; and

FIG. 8 illustrates a diagram for the method of stamping an embossment on bilateral ribbon using the preferred embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

While the specification concludes with claims defining the features of the invention that are regarded as novel, it is believed that the invention will be better understood from a consideration of the following description in conjunction with the figures, in which like reference numerals are carried forward.

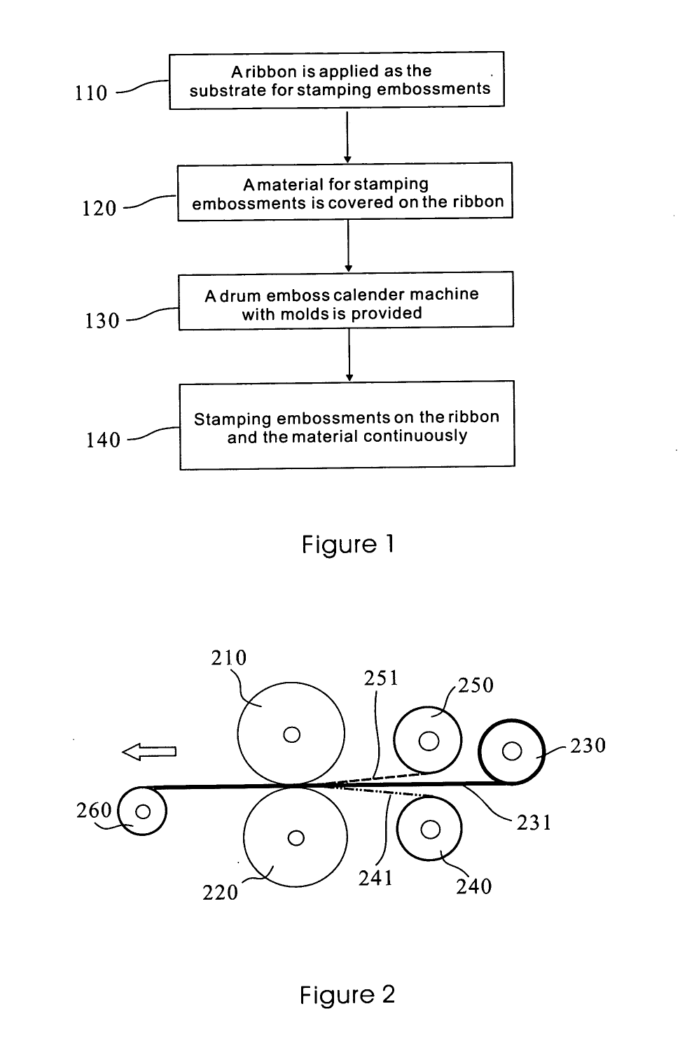

Reference is made to FIG. 1, which illustrates a step flowchart for the method of stamping an embossment on ribbon using the preferred embodiment of the present invention.

In step 110, a ribbon is applied as the substrate on which the embossment is stamped. In the preferred embodiment of the present invention, the ribbon can be a knitted ribbon made by knitting cloth or weaving cloth which comprises cotton, polyester fiber, nylon fiber, tetolon fiber, glass fiber, polyester nylon fiber mixed yarn or a combination thereof. Furthermore, the ribbon can also be thermoplastic film, like TPU, PVC or made from other appropriate thermoplastic films.

In step 120, the material on which the embossment is stamped covers the ribbon. In the preferred embodiment of the present invention, the materials comprise TPU, PVC, reflecting films, laser films or a combination thereof.

In step 130, a drum emboss calender machine with molds is provided. The ribbons and the materials on which the embossments are stamped are taken to the machine together. Finally, the embossments are continuously stamped on the ribbons and the materials as shown in step 140.

Reference is made to FIG. 2, which illustrates a diagram for the method of stamping an embossment on ribbon using a preferred embodiment of the present invention. A plurality of ribbons 231, the material 241, and the material 251 are separately rolled on the roller 230, the roller 240 and the roller 250. The roller 260 rolls the ribbon 231, the material 241 and the material 251 through the middle of the upper and lower rollers of the drum emboss calender machine.

The roller 210 not only presses and heats, but also stamps embossments on the surface or the molds. The roller 220 forces the ribbon 231, the material 241 and the material 251 forward in the direction of the arrowhead, and stamps embossments on the ribbon 131 continuously with the pressing and the rolling of the roller 210 and roller 220. This results in stereo embossments on the ribbon 231.

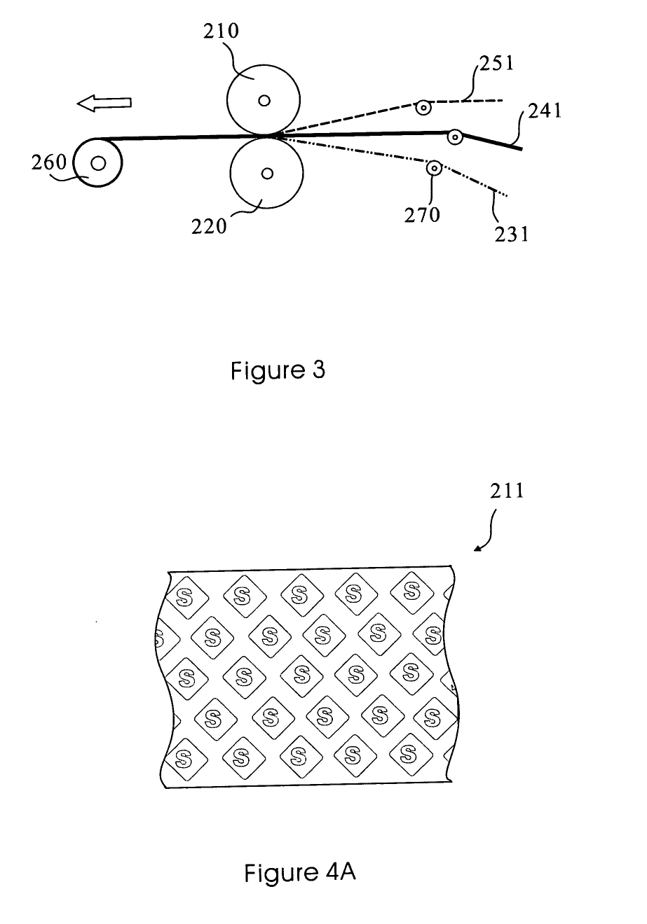

Reference is made to FIG. 3, which illustrates a diagram for entire automatic method of stamping an embossment on ribbon using a preferred embodiment of the present invention. The method can be connected to the production line of previous processes, and the ribbon and the material made in the production line of previous processes can connect with the roller 270. The roller 260 rolls the ribbon 231, the material 241 and the material 251 through the middle of the upper and lower rollers of the drum emboss calender machine, so the production made in the production line of previous processes can be stamped directly and the entire production process can be automated.

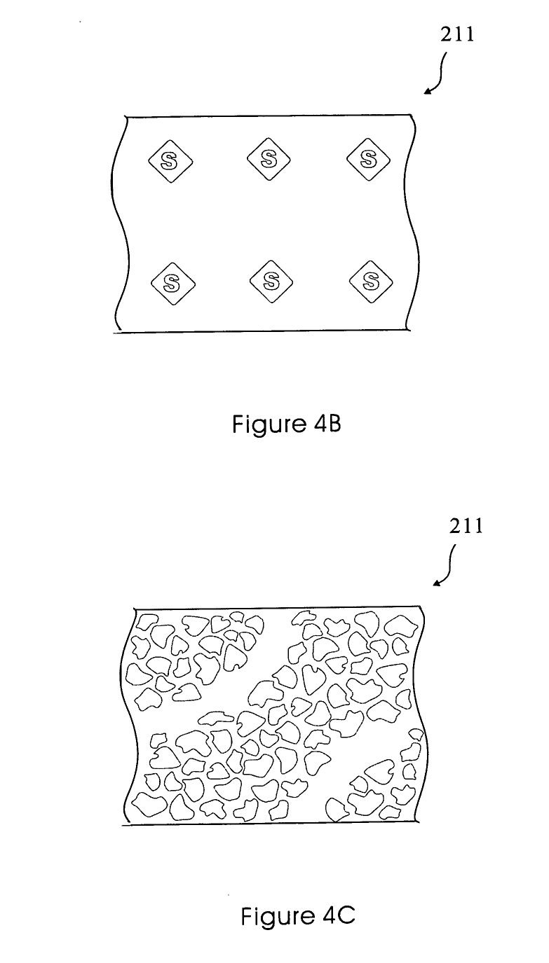

Etching embossments and the molds set on the roller can be arranged continuously depending on the need as shown in FIG. 4A or arranged discontinuously as shown in FIG. 4B, even the embossments can be irregular as shown in FIG. 4C. The stereo embossments can be convex or concaves using the intaglio etching method or the relief etching method. By this method, the trace crossed with the rough and the shiny areas can be displayed on the surface of the ribbon and the contrast of the embossments will be more apparent in order to enhance the stereo effect and changeability.

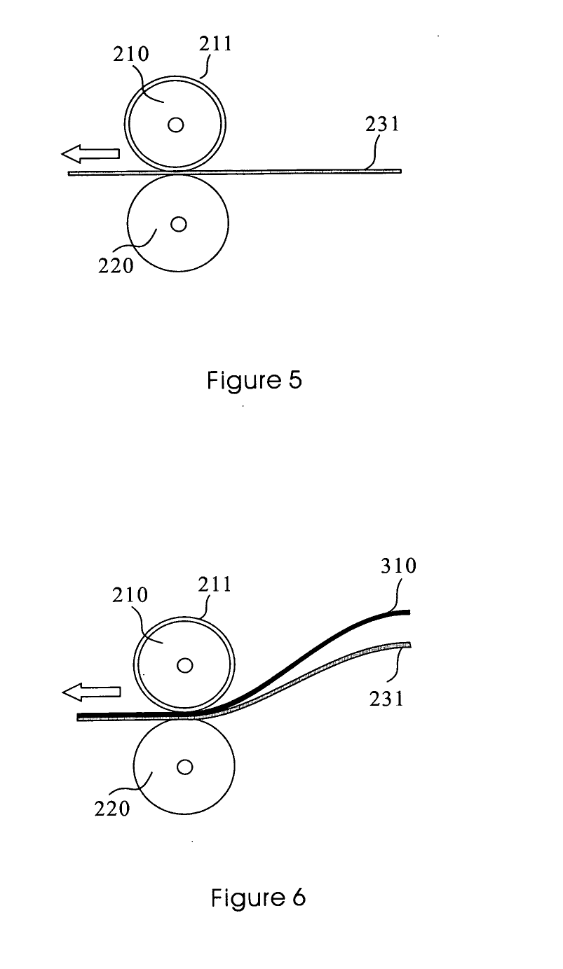

Reference is made to FIG. 5, which illustrates a diagram for the method of stamping an embossment on single ribbon using a preferred embodiment of the present invention. The ribbon can be stamped alone. The drum emboss calender machine comprises two rollers located in the upper and lower parts in which the roller 210 can press and heat, and the mold 211 with the stamping embossments are set on it. The roller 220 rolls the ribbon 231 forward in the arrowhead direction and the stereo embossments will be stamped on the ribbon 231 by the pressing and rolling of the roller 210 and the roller 220.

Reference is made to FIG. 6, which illustrates a diagram for the method of stamping an embossment on ribbon with single material using a preferred embodiment of the present invention. First, the ribbon 231 is used as the stamping substrate, and the material 310 covers it. In the preferred embodiment of the present invention, the ribbon 231 is a knitted ribbon and the material 310 is TPU or PVC. Then, the ribbon 231 moves forward in the arrowhead direction, and the stereo embossments are stamped on the ribbon 231 and the material 310 continuously by the pressing and rolling of the roller 210 and the roller 220. In another preferred embodiment of the present invention, the ribbon 231 can be a knitted ribbon and the material 310 can also be a reflecting or laser film; therefore, the reflecting or laser knitted ribbon with stereo embossments can be produced through the said method.

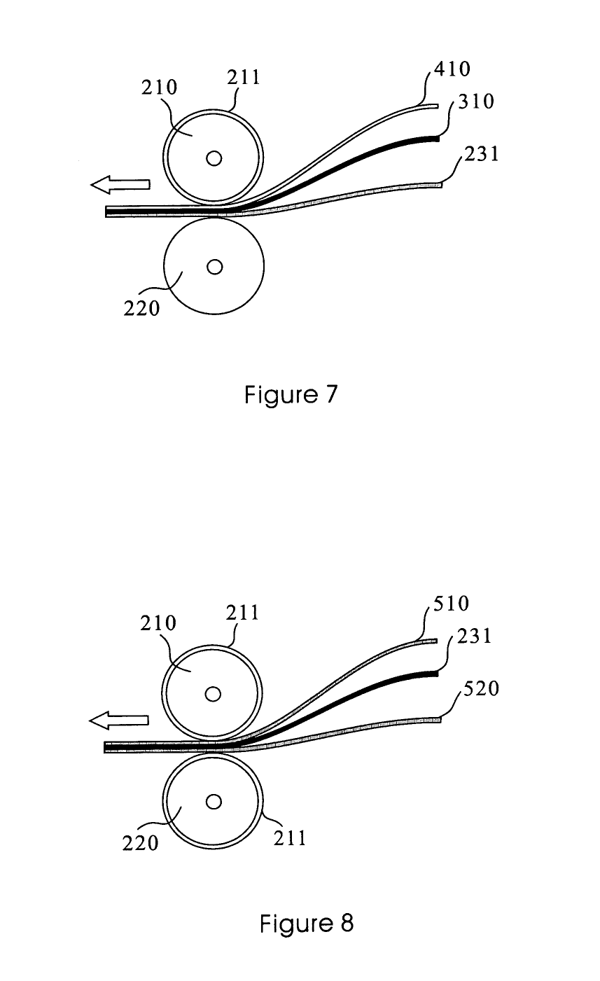

Reference is made to FIG. 7, which illustrates another diagram for a method of stamping an embossment on ribbon with two materials using a preferred embodiment of the present invention. The drum emboss calender machine comprises two rollers located in the upper and lower parts in which the mold 211 with the stamping embossments are set on the roller 210. The roller 220 rolls the ribbon 231 forward in the arrowhead direction. The ribbon 231 is the substrate for stamping, and the material 310 and the material 410 cover it. The ribbon 231 is a knitted ribbon, the material 310 is a reflecting or laser film, and the material 410 is TPU or PVC. Then, the ribbon 231 moves forward in the arrowhead direction, and the reflecting or laser films with stereo embossments are stamped on the ribbon 231, the material 310 and the material 410 continuously by the pressing and rolling of the roller 210 and the roller 220; as a result, the reflecting or laser knitted ribbon with stereo embossments is produced.

In another preferred embodiment of the present invention, the arrangement of the materials can be set like a sandwich, and the embossments can be stamped unilaterally or bilaterally. As shown in FIG. 7, the ribbon 231 is TPU or PVC, the material 310 is a reflecting or laser film, and the material 410 is TPU or PVC. Subsequently, the embossments are continuously stamped on the ribbon 231, the material 410 and the material 310. Therefore, reflecting or laser films with stereo embossment can be produced through the said method.

Reference is made to FIG. 8, which illustrates yet another preferred embodiment of the present invention. The ribbon is a knitted ribbon, and both the material 510 and the material 520 are TPU or PVC. Both the material 510 and the material 520 are attached to the knitted ribbon bilaterally. Therefore, the method of stamping by the pressing and rolling of the upper and lower rollers in which the mold 211 is set can be used to produce the bilateral knitted ribbon with stereo embossments.

Although the present invention has been described in considerable detail with reference certain preferred embodiments thereof, other embodiments are possible. For example, the stamping embossments can be any appropriate patterns or words. Therefore, the spirit and scope of the appended claims should no be limited to the description of the preferred embodiments container herein.

According to the composition and the embodiments above, there are many advantages of the present invention over the prior art, such as:

First, the method for stamping an embossment of the present invention enables continuous stamping that not only decreases the complexity of the process but also shortens the manufacturing time so goals, including easy operation, rapid manufacturing, and less cost, can be achieved.

Secondly, the method for stamping an embossment of the present invention can be used to continuously or discontinuously stamp stereo embossments on the ribbon using different embossment arrangements on the molds, and also create one-piece ribbon with stereo embossments. As a result, a functional and stylish knitted ribbon is provided and different visual effects are also displayed on it. Compared to general methods of attaching or sewing reflecting bars to knitted ribbon, the present invention not only decreases the complexity of the process but also maintains the thickness and the hardness of the knitted ribbon so that it can be applied more extensively and boost the market competitiveness.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for stamping an embossment on ribbon, comprising:
providing a ribbon which is used as the substrate for stamping an embossment;
providing a drum emboss calender machine, wherein the stamping embossments are attached to the rollers; and
stamping the embossments on the ribbon continuously.

2. The method for stamping an embossment on ribbon of claim 1, wherein the ribbon is a knitted ribbon.

3. The method for stamping an embossment on ribbon of claim 2, wherein the materials of the knitted ribbon comprise cotton, polyester fiber, nylon fiber, tetolon fiber, glass fiber, polyester nylon fiber mixed yarn or a combination thereof.

4. The method for stamping an embossment on ribbon of claim 1, wherein the ribbon is a thermoplastic film.

5. The method for stamping an embossment on ribbon of claim 4, wherein the material of the thermoplastic film is thermoplastic polyurethane elastomer (TPU) or polyvinyl chloride (PVC).

6. The method for stamping an embossment on ribbon of claim 1, wherein the embossment is a continuous arrangement.

7. The method for stamping an embossment on ribbon of claim 1, wherein the embossment is a discontinuous arrangement.

8. A method for stamping an embossment on ribbon, comprising:
providing a ribbon which is used as the substrate for stamping an embossment;
providing at least a material for stamping an embossment which is covered on the ribbon;
providing a drum emboss calender machine, wherein the stamping embossments are attached to the rollers; and
stamping the embossments on the ribbon and the material continuously.

9. The method for stamping an embossment on ribbon of claim 8, wherein the ribbon is a knitted ribbon.

10. The method for stamping an embossment on ribbon of claim 9, wherein the materials of the knitted ribbon at least comprise cotton, polyester fiber, nylon fiber, tetolon fiber, glass fiber, polyester nylon fiber mixed yarn or a combination thereof.

11. The method for stamping an embossment on ribbon of claim 8, wherein the ribbon is a thermoplastic film.

12. The method for stamping an embossment on ribbon of claim 9, wherein the material of the thermoplastic film is thermoplastic polyurethane elastomer (TPU) or polyvinyl chloride (PVC).

13. The method for stamping an embossment on ribbon of claim 8, wherein the material is TPU, PVC, reflecting film, laser film or a combination thereof.

14. The method for stamping an embossment on ribbon of claim 8, wherein the embossment is a continuous arrangement.

15. The method for stamping an embossment on ribbon of claim 8, wherein the embossment is a discontinuous arrangement.

16. A method for stamping an embossment on ribbon, comprising:
providing a ribbon which is used as the substrate for stamping an embossment;
providing a plurality of materials for stamping an embossment which are covered on the ribbon bilaterally;
providing a drum emboss calender machine, wherein the stamping embossments are attached to the rollers; and
stamping the embossments on the ribbon and the materials continuously.

17. The method for stamping an embossment on ribbon of claim 12, wherein the materials of the knitted ribbon at least comprise cotton, polyester fiber, nylon fiber, tetolon fiber, glass fiber, polyester nylon fiber mixed yarn or a combination thereof.

18. The method for stamping an embossment on ribbon of claim 12, wherein the material is TPU, PVC, reflecting film, laser film or a combination thereof.

19. The method for stamping an embossment on ribbon of claim 16, wherein the embossment is a continuous arrangement.

20. The method for stamping an embossment on ribbon of claim 16, wherein the embossment is a discontinuous arrangement.
